(19) United States
(12) Patent Application Publication
(10) Pub. No.: US 2026/0010409 A1
(43) Pub. Date: Jan. 8, 2026

(54) DENORMALIZING OPERATOR ACTIVITY FOR DEPLOYMENT OF CONTAINERIZED APPLICATIONS

(71) Applicant: RED HAT, INC., Raleigh, NC (US)

(72) Inventors: Paolo Antinori, Novara (IT); Jakub Senko, Brno (CZ)

(21) Appl. No.: 18/761,442

(22) Filed: Jul. 2, 2024

(51) Int. Cl. G06F 9/50; G06F 8/60

(52) U.S. Cl. CPC G06F 9/5055; G06F 8/60

(57) ABSTRACT

Operator activity for deployment of containerized applications can be denormalized according to techniques described herein. For example, a behavior processing component can record one or more actions performed by an operator that is deploying a containerized application to one or more first nodes of a first cluster. The behavior processing component can determine that the containerized application is in a desired state. In response, the behavior processing component can generate one or more resources usable to deploy the containerized application based on the recorded one or more actions. The one or more resources can be used to automatically deploy the containerized application in one or more second nodes of a second cluster.

### TECHNICAL FIELD

The present disclosure relates generally to containerized applications. More specifically, but not by way of limitation, this disclosure relates to denormalizing operator activity for deployment of containerized applications.

### BACKGROUND

To help automate the deployment, scaling, and management of software resources inside containers, some distributed computing environments may include container orchestration platforms. Container orchestration platforms can help manage containers to reduce the workload on users. One example of a container orchestration platform is Kubernetes. Distributed computing environments running Kubernetes can be referred to as Kubernetes environments.

Kubernetes environments can include software operators (“operators”) for automating various repeatable tasks, such as deployment, scaling, and backup of software resources. In the context of Kubernetes, an operator is a software extension that can manage an assigned software resource, such as a stateful application. Once deployed, operators can create, configure, and manage instances of their assigned software resources on behalf of a user in a declarative way.

### BRIEF DESCRIPTION OF THE DRAWINGS

FIG. 1 is a block diagram of an example of a system for denormalizing operator activity for deployment of containerized applications, according to some aspects of the present disclosure.

FIG. 2 is a block diagram of another example of a system for denormalizing operator activity for deployment of containerized applications, according to some aspects of the present disclosure.

FIG. 3 is a flowchart of an example of a process for denormalizing operator activity for deployment of containerized applications, according to some aspects of the present disclosure.

### DETAILED DESCRIPTION

Software operators (also referred to herein as “operators”) can be installed and updated in a distributed computing environment to deploy and manage software applications in the distributed computing environment. The operators can be software extensions that can automate application-specific tasks such as deployment, scaling, upgrades, or the like. The operators can automate the application-specific tasks using custom resources and custom controllers. The custom resources can include configuration files, which may define a desired state of a software application or of a computing cluster (also referred to herein as a “cluster”) in which the software application may be deployed. The custom controllers can then automatically provision or reconfigure computing resources in the distributed computing environment to maintain the desired state of the software application or cluster.

In some cases, the use of operators may not be desired for users that have relatively strict governance policies that require manual approval of some intermediate steps that an operator may automatically perform. In such situations, users may instead manually replicate the actions of an operator, particularly during an installation phase of a software application. Further, although using operators can be helpful in automating deployment (or other operations) of software applications, a bug in the operator can cause instability (e.g., degrade performance and increase latency) of the software application being managed by the operator. If an operator is faulty, manual intervention may be required to correct behavior of the operator. It may therefore be beneficial to gain increased control and insight over operator behavior.

Some examples of the present disclosure can overcome one or more of the issues mentioned above by denormalizing operator behavior to automatically deploy containerized applications. A behavior processing component can extract the resources used to deploy a software application by analyzing the behavior of an operator in a test cluster. Once this process is performed, the extracted resources can be used to automatically deploy the application without the use of an operator in a new cluster. In this way, insights into the “black box” nature of the operator can be gained and replicated without requiring the use of the operator. In some examples, the behavior processing component can also reduce, combine, or reorder actions performed in the new cluster to reduce latency or more efficiently deploy and configure the software application. For example, the operator may perform several actions in an attempt to reach the desired state of the software application. The behavior processing component may replicate the final state of resources used to deploy the software application in the test cluster without replicating the intermediate steps. This can significantly reduce latency and computing resources required to successfully deploy the software application in the new cluster.

One particular example can involve clusters that are running Kubernetes as a container orchestration platform. The clusters may run containerized applications (e.g., applications run in isolated containers) deployed by an operator. To deploy the same containerized application to multiple clusters, an operator and a behavior processing component can be deployed to a first cluster (e.g., a test cluster). The behavior processing component can monitor the resources and the actions performed by the operator while deploying the containerized application to the first cluster. For example, one or more proxies can intercept actions performed by the operator, such as application programming interface (API) calls or communication between the containerized application and the operator. The proxies can notify the behavior processing component of the actions and resources used by the operator for the behavior processing component to record.

The operator may continue to perform actions, in some cases autotuning settings or values of the resources, until the containerized application has reached a desired state (e.g., as defined by a configuration file for the containerized application). At this point, the behavior processing component may identify a final state of the resources used to deploy the containerized application. The behavior processing component can extract resources in their final state as well as actions performed on such resources. The extracted resources can then be applied to other clusters running Kubernetes to automatically deploy the same containerized application without using the operator.

For example, the behavior processing component can generate a code-generated executable application (e.g., a configurator) that can reproduce operator actions that cannot directly be represented by the recorded resources. The configurator can reproduce the operator actions in the other clusters by ensuring that the actions are replayed in the correct order or retried in case of failure. In more complex cases, the configurator can reorder the actions to improve speed, combine multiple actions into a single action, try an alternative but equivalent action in case of failures, or support application-specific security schemes. Thus, the behavior processing component can apply resulting artifacts to different clusters, and duplicates of the original containerized application can be deployed without needing to use the operator.

Although software extensions for deploying and managing software applications according to various aspects are referred to herein as “operators,” embodiments described herein can apply similarly and equivalently to any software tools used to deploy and manage software applications in distributed computing environments. For example, the operators described herein can be middleware, web browser extensions, automation tools (e.g., Ansible), API gateways and service meshes, or the like.

Illustrative examples are given to introduce the reader to the general subject matter discussed herein and are not intended to limit the scope of the disclosed concepts. The following sections describe various additional features and examples with reference to the drawings in which like numerals indicate like elements, and directional descriptions are used to describe the illustrative aspects, but, like the illustrative aspects, should not be used to limit the present disclosure.

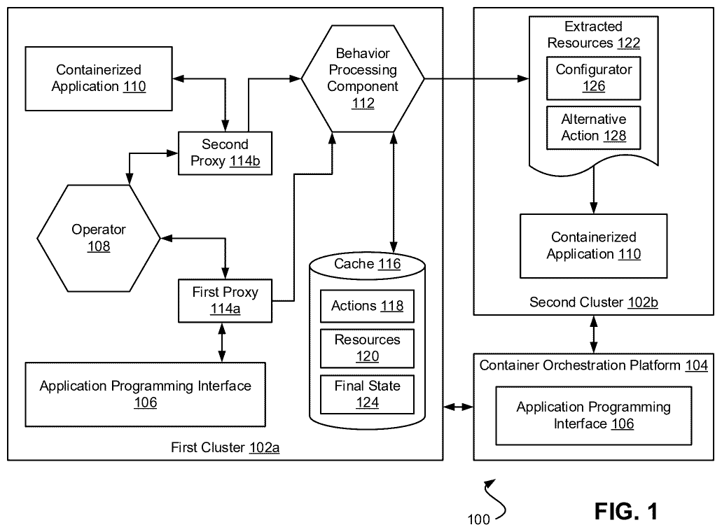

FIG. 1 is a block diagram of an example of a system 100 for denormalizing operator activity for deployment of containerized applications, according to some aspects of the present disclosure. Components within the system 100 may be communicatively coupled via a network, such as a local area network (LAN), wide area network (WAN), the Internet, a vehicle bus, or any combination thereof. The system 100 can include one or more computing clusters (“clusters”) 102a-b that may be formed from multiple nodes (e.g., servers or other computing devices) in communication with one another over one or more networks. Examples of the one or more networks can include a local area network (LAN), a wide area network (WAN), the Internet, or any combination thereof. The nodes may communicate with one another to collectively perform tasks in the clusters 102a-b. For example, the nodes can communicate with one another to perform distributed data processing or other distributed projects in each cluster 102.

The system 100 can further include a container orchestration platform 104 such as Kubernetes that can assist with managing (e.g., deploying, scaling, maintaining, etc.) software resources (“resources”) inside containers within the clusters 102a-b. To that end, the container orchestration platform 120 can, in some examples, store objects, such as data structures representing the resources. The resources can include microservices or serverless functions that can collectively implement the overall functionality of a software application. The container orchestration platform 104 can further include an application programming interface (API) 106, which can be a central interface through with operational instructions for a cluster can be communicated. In examples where the container orchestration platform 104 is Kubernetes, the API 106 can be a representational state transfer (REST) API that can provide a way for both human administrators and automated tools (e.g., the operator 108) to interact with the first cluster 102a. The container orchestration platform 104 can include an operator management system (not pictured) that can manage installation and operation of an operator 108 at the first cluster 102a. The operator management system may do so via communication with the API 106. In the context of Kubernetes, the operator management system can be part of an operator lifecycle manager (OLM), or the operator management system can be separate from and communicatively coupled to the OLM.

In some examples, a user may wish to deploy a containerized application 110 to multiple clusters, including the first cluster 102a and second cluster 102b. To efficiently install the containerized application 110 to multiple clusters, the container orchestration platform 104 may first install an operator 108 to the first cluster 102a. For example, the container orchestration platform 104 may create an instance of a custom resource definition that can cause the operator 108 to start deploying the containerized application 110. The operator 108 can perform actions 118 to deploy and configure the containerized application 110 to the first cluster 102a. For example, the operator 108 may perform API calls to the API 106 to configure instances of resources 120 (e.g., objects) associated with the containerized application 110. The operator 108 may also communicate directly with the containerized application 110, such as to configure application-specific features. For example, the operator 108 may generate, delete, or modify the resources 120 such as by setting values of fields within the resources 120 to deploy the containerized application 110. The operator 108 may manage the containerized application 110 until a desired state (e.g., as defined by a configuration file for the containerized application 110) is reached. Reaching the desired state of the containerized application 110 may take some time.

A behavior processing component 112 can be installed on the first cluster 102a before the operator 108 begins deploying the containerized application 110. The behavior processing component 112 can monitor the actions 118 performed by the operator 108 and the resources 120 used by the operator 108 to deploy the containerized application 110. For example, the behavior processing component 112 can use one or more proxies to intercept actions 118 performed by the operator. In the example depicted in FIG. 1, a first proxy 114a can intercept API calls made by the operator 108 to the API 106 for the container orchestration platform 104. In some examples, a second proxy 114b can intercept communications between the operator 108 and the containerized application 110. The behavior processing component 112 can receive indications of the actions 118 and the resources 120 from the proxies 114a-b. The behavior processing component 112 can record the actions 118 and the resources 120 in a cache 116. The entire process of the operator 108 deploying the containerized application 110 and configuring the containerized application 110 into the desired state can be monitored and recorded by the behavior processing component 112.

After the desired state is reached (e.g., as confirmed by comparing the state of the containerized application 110 to the configuration file specifying the desired state), the behavior processing component 112 can create a checkpoint that corresponds to the sequence of actions 118 that have been recorded up to that point. The behavior processing component 112 can then analyze the recorded actions 118 and resources 120 to generate output artifacts (e.g., extracted resources 122) that can be used to deploy another instance of the containerized application 110 in other clusters, such as the second cluster 102b. In some examples, the extracted resources 122 can be in the form of a Kubernetes resource template. The extracted resources 122 can be based on a final state 124 of the resources 120 used (e.g., created, updated, or deleted) by the operator 108 in deploying the containerized application 110 to the first cluster 102a.

The extracted resources 122 can be used to deploy the containerized application 110, in its configuration as recorded up to the checkpoint moment, in the second cluster 102b. In examples where most or all of the recorded actions 118 have originated from the API 106, using the extracted resources 122 to deploy the containerized application 110 to the second cluster 102b may be sufficient. In other examples, the behavior processing component 112 may additionally generate a configurator 126 (e.g., a code-generated executable application) that can reproduce actions 118 that cannot be directly represented by resources (e.g., Kubernetes resources) only, typically to reproduce actions 118 that have been intercepted by the second proxy 114b. As an example, these actions 118 may be invocations of the REST API for the containerized application 110, which may have to be reproduced by the code-generated configurator 126. In a general example, the configurator 126 can simply ensure that the actions 118 are replayed in a correct order or may retry actions 118 in case of failure.

For more relatively complex use cases, use of the behavior processing component 112 and the second proxy 114b can be extended with domain or protocol specific logic. For example, if the containerized application 110 is a Kafka cluster, the operator 108 may have configured the containerized application 110 in the first cluster 102a using an application-specific binary protocol. The behavior processing component 112 and the second proxy 114b can be configured to understand the application-specific binary protocol can enable the behavior processing component 112 to generate a configurator 126 that can modify implementations of the recorded actions 118 performed by the operator 108. For example, the operator 108 can reorder the actions 118 to improve speed of deployment in the second cluster 102b. Additionally, the configurator 126 may also identify when an action 118 has failed and can identify an alternative action 128 that can be performed instead (e.g., based on the configuration file for the containerized application 110). The configurator 126 may automatically perform the alternative action 128 in case of failure. In some examples, the configurator 126 may also combine multiple actions 118 into a single action. Such a configurator 126 that can use the application-specific binary protocol may be packages as a container image and may include the extracted resources 122.

The resulting output artifacts (e.g., the extracted resources 122 and the configurator 126) can thus be applied to the second cluster 102b (and additional clusters) to deploy the containerized application 110 without using the operator 108. Deploying additional instances of the containerized application 110 to additional clusters with the output artifacts and without the operator 108 can be performed significantly faster and with more efficient use of computing resources compared to deploying instances of the containerized application 110 to multiple clusters using operators.

Although FIG. 1 depicts a certain number and arrangement of components, other examples may include more components, fewer components, different components, or a different number of the components that is shown in FIG. 1. For instance, the system 100 can include more clusters or proxies than are shown in FIG. 1.

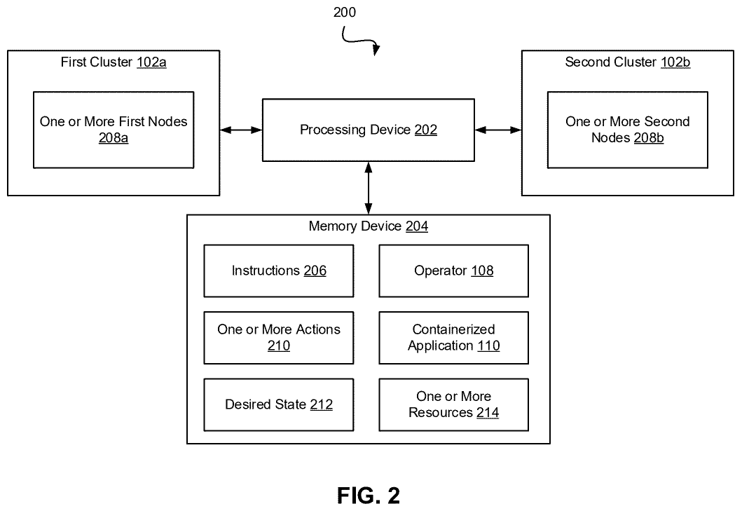

FIG. 2 is a block diagram of another example of a system 200 for denormalizing operator activity for deployment of containerized applications, according to some aspects of the present disclosure. The system 200 depicted in FIG. 2 includes a processing device 202 communicatively coupled with a memory device 204. In some examples, the components of the system 200, such as the processing device 202 and the memory device 204, may be part of a same computing device. In other examples, the processing device 202 and the memory device 204 can be included in separate computing devices that are communicatively coupled.

The processing device 202 can include one processing device or multiple processing devices. Non-limiting examples of the processing device 202 include a Field-Programmable Gate Array (FPGA), an application-specific integrated circuit (ASIC), a microprocessor, etc. The processing device 202 can execute instructions 206 stored in the memory device 204 to perform operations. In some examples, the instructions 206 can include processor-specific instructions generated by a compiler or an interpreter from code written in any suitable computer-programming language, such as C, C++, C#, etc.

The memory device 204 can include one memory or multiple memories. The memory device 204 can be non-volatile and may include any type of memory that retains stored information when powered off. Non-limiting examples of the memory device 204 include electrically erasable and programmable read-only memory (EEPROM), flash memory, or any other type of non-volatile memory. At least some of the memory can include a non-transitory computer-readable medium from which the processing device 202 can read instructions 206. The non-transitory computer-readable medium can include electronic, optical, magnetic, or other storage devices capable of providing the processing device with computer-readable instructions or other program code. Examples of the non-transitory computer-readable medium include magnetic disk(s), memory chip(s), ROM, RAM, an ASIC, a configured processor, optical storage, or any other medium from which a computer processor can read the instructions 206.

In some examples, the processing device 202 can execute the instructions 206 to perform some or all of the functionality described herein. For example, the processing device 202 can record one or more actions 210 performed by an operator 108 that is deploying a containerized application 110 to one or more first nodes 208a of a first cluster 102a. The processing device 202 can determine that the containerized application 110 is in a desired state 212. The processing device 202 can generate one or more resources 214 usable to deploy the containerized application 110 based on the recorded one or more actions 210 and in response to determining that the containerized application 110 is in the desired state 212. The processing device 202 can use the one or more resources to automatically deploy the containerized application 110 to one or more second nodes 208b of a second cluster 102b.

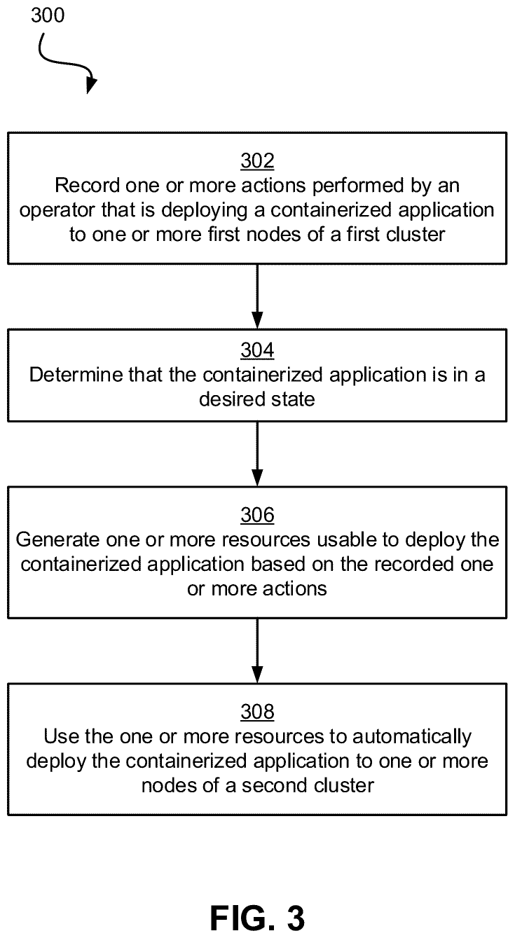

FIG. 3 is a flowchart of an example of a process 300 for denormalizing operator activity for deployment of containerized applications, according to some aspects of the present disclosure. In some examples, the processing device 202 can implement some or all of the steps shown in FIG. 3. Additionally, in some examples, the processing device 202 can be executing the operator 108, the behavior processing component 112, the configurator 126, the container orchestration platform 104, or any suitable component of FIG. 1 to implement some or all of the steps shown in FIG. 3. Other examples can include more steps, fewer steps, different steps, or a different order of the steps than is shown in FIG. 3. The steps of FIG. 3 are discussed below with reference to the components discussed above in relation to FIGS. 1 and 2.

At block 302, the processing device 202 can record one or more actions 210 performed by an operator 108 that is deploying a containerized application 110 to one or more first nodes 208a of a first cluster 102a. For example, the processing device 202 can maintain a cache 116 identifying resources 120 that the operator 108 has acted upon in deploying the containerized application 110 to the one or more first nodes 208a. The processing device 202 may detect the one or more actions 210 via a proxy 114 that can intercept the one or more actions 210 performed by the operator 108 to deploy the containerized application 110.

At block 304, the processing device 202 can determine that the containerized application 110 is in a desired state 212. For example, the processing device 202 may determine that the containerized application 110 is in the desired state 212 by accessing a configuration file for the containerized application 110 that indicates the desired state 212. The operator 108 may autotune the containerized application 110 (e.g., by varying settings, configurations, values, etc.) until the containerized application 110 reaches the desired state 212.

At block 306, the processing device 202 can, in response to determining that the containerized application 110 is in the desired state 212, generate one or more resources 214 (e.g., extracted resources 122) usable to deploy the containerized application 110 based on the recorded one or more actions 210. For example, the processing device 202 can identify a final state 124 of each of the resources 120 in the desired state 212 of the containerized application 110 and can generate the one or more resources 214 based on the final state 124 of the recorded resources 120. In some examples, the processing device 202 can generate a configurator 126 that can reproduce the one or more actions 118 performed by the operator 108 in deploying the containerized application 110.

At block 308, the processing device 202 can use the one or more resources 214 to automatically deploy the containerized application 110 to one or more second nodes 208b of a second cluster 102b. In some examples, the processing device 202 can automatically deploy the containerized application 110 to the one or more second nodes 208b without the operator 108. In some examples, the processing device 202 can execute the configurator 126 to reorder the one or more actions 210 or combine the one or more actions 210 into a single action to automatically deploy the containerized application 110. In some examples, the processing device 202 can execute the configurator 126 to identify a failed action performed by the configurator 126 in automatically deploying the containerized application 110. The processing device 202 can then execute the configurator 126 to identify an alternative action 128 that is equivalent to the failed action and to automatically execute the alternative action 128 to deploy the containerized application 110 to the one or more second nodes 208b.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure.

What is claimed is:

1. A system comprising:
a processing device; and
a memory device comprising instructions that are executable by the processing device for causing the processing device to:
record one or more actions performed by an operator that is deploying a containerized application to one or more first nodes of a first cluster;
determine that the containerized application is in a desired state;
in response to determining that the containerized application is in the desired state, generate one or more resources usable to deploy the containerized application based on the recorded one or more actions; and
use the one or more resources to automatically deploy the containerized application to one or more second nodes of a second cluster.

2. The system of claim 1, wherein the memory device further comprises instructions that are executable by the processing device for causing the processing device to:
maintain a cache identifying a plurality of resources that the operator has acted upon in deploying the containerized application to the one or more first nodes;
identify a final state of each resource of the plurality of resources in the desired state of the containerized application; and
generate the one or more resources based on the final state of each resource of the plurality of resources.

3. The system of claim 1, wherein the memory device further comprises instructions that are executable by the processing device for causing the processing device to:
detect the one or more actions via a proxy configured to intercept the one or more actions performed by the operator to deploy the containerized application.

4. The system of claim 1, wherein the memory device further comprises instructions that are executable by the processing device for causing the processing device to generate the one or more resources usable to deploy the containerized application by:
generating a configurator that is configured to reproduce the one or more actions performed by the operator in deploying the containerized application.

5. The system of claim 4, wherein the memory device further comprises instructions that are executable by the processing device for causing the processing device to automatically deploy the containerized application to the one or more second nodes by:
reordering, by the configurator, the one or more actions; or
combining, by the configurator, the one or more actions into a single action.

6. The system of claim 4, wherein the memory device further comprises instructions that are executable by the processing device for causing the processing device to automatically deploy the containerized application to the one or more second nodes by:
identifying, by the configurator, a failed action performed by the configurator in automatically deploying the containerized application;
identifying, by the configurator, an alternative action that is equivalent to the failed action; and
automatically executing, by the configurator, the alternative action to deploy the containerized application to the one or more second nodes.

7. The system of claim 1, wherein the memory device further comprises instructions that are executable by the processing device for causing the processing device to automatically deploy the containerized application to the one or more second nodes without the operator.

8. A method comprising:
recording, by a processing device, one or more actions performed by an operator that is deploying a containerized application to one or more first nodes of a first cluster;
determining, by the processing device, that the containerized application is in a desired state;
in response to determining that the containerized application is in the desired state, generating, by the processing device, one or more resources usable to deploy the containerized application based on the recorded one or more actions; and
using, by the processing device, the one or more resources to automatically deploy the containerized application to one or more second nodes of a second cluster.

9. The method of claim 8, further comprising:
maintaining a cache identifying a plurality of resources that the operator has acted upon in deploying the containerized application to the one or more first nodes;
identifying a final state of each resource of the plurality of resources in the desired state of the containerized application; and
generating the one or more resources based on the final state of each resource of the plurality of resources.

10. The method of claim 8, further comprising:
detecting the one or more actions via a proxy configured to intercept the one or more actions performed by the operator to deploy the containerized application.

11. The method of claim 8, wherein generating the one or more resources usable to deploy the containerized application further comprises:
generating a configurator that is configured to reproduce the one or more actions performed by the operator in deploying the containerized application.

12. The method of claim 11, wherein automatically deploying the containerized application to the one or more second nodes further comprises:
reordering, by the configurator, the one or more actions; or
combining, by the configurator, the one or more actions into a single action.

13. The method of claim 11, wherein automatically deploying the containerized application to the one or more second nodes further comprises:
identifying, by the configurator, a failed action performed by the configurator in automatically deploying the containerized application;
identifying, by the configurator, an alternative action that is equivalent to the failed action; and
automatically executing, by the configurator, the alternative action to deploy the containerized application to the one or more second nodes.

14. The method of claim 8, wherein the containerized application is automatically deployed to the one or more second nodes without the operator.

15. A non-transitory computer-readable medium comprising program code that is executable by a processing device for causing the processing device to:
record one or more actions performed by an operator that is deploying a containerized application to one or more first nodes of a first cluster;
determine that the containerized application is in a desired state;
in response to determining that the containerized application is in the desired state, generate one or more resources usable to deploy the containerized application based on the recorded one or more actions; and
use the one or more resources to automatically deploy the containerized application to one or more second nodes of a second cluster.

16. The non-transitory computer-readable medium of claim 15, further comprising program code that is executable by the processing device for causing the processing device to:
maintain a cache identifying a plurality of resources that the operator has acted upon in deploying the containerized application to the one or more first nodes;
identify a final state of each resource of the plurality of resources in the desired state of the containerized application; and
generate the one or more resources based on the final state of each resource of the plurality of resources.

17. The non-transitory computer-readable medium of claim 15, further comprising program code that is executable by the processing device for causing the processing device to:
detect the one or more actions via a proxy configured to intercept the one or more actions performed by the operator to deploy the containerized application.

18. The non-transitory computer-readable medium of claim 15, further comprising program code that is executable by the processing device for causing the processing device to generate the one or more resources usable to deploy the containerized application by:
generating a configurator that is configured to reproduce the one or more actions performed by the operator in deploying the containerized application.

19. The non-transitory computer-readable medium of claim 18, further comprising program code that is executable by the processing device for causing the processing device to automatically deploy the containerized application to the one or more second nodes by:
reordering, by the configurator, the one or more actions; or
combining, by the configurator, the one or more actions into a single action.

20. The non-transitory computer-readable medium of claim 18, further comprising program code that is executable by the processing device for causing the processing device to automatically deploy the containerized application to the one or more second nodes by:
identifying, by the configurator, a failed action performed by the configurator in automatically deploying the containerized application;
identifying, by the configurator, an alternative action that is equivalent to the failed action; and
automatically executing, by the configurator, the alternative action to deploy the containerized application to the one or more second nodes.
